(19) United States
(12) Patent Application Publication
(10) Pub. No.: US 2021/0062656 A1
(43) Pub. Date: Mar. 4, 2021

(54) KEY WASHER FOR A GAS TURBINE ENGINE

(71) Applicant: PRATT & WHITNEY CANADA CORP., Longueuil (CA)

(72) Inventors: Acher-Igal ABENHAIM, Cote Saint Luc (CA); Vincent PARADIS, Longueuil (CA); Marc-Antoine MAILLOUX-LABROUSSE, Montreal (CA); Alexander SMITH, Montreal (CA)

(21) Appl. No.: 16/558,951

(22) Filed: Sep. 3, 2019

(51) Int. Cl. F01D 5/06; F01D 25/00

(52) U.S. Cl. CPC F01D 5/06; F05D 2240/24; F01D 25/00

(57) ABSTRACT

A gas turbine engine comprising: a shaft about an axis; a first turbine assembly mounted to the shaft, a first flow path and a second flow path extending through first turbine assembly along the axis. The second flow path is located radially inward of the first flow path relative to the axis. A second turbine assembly is about the axis downstream of the first turbine assembly, with a gap defined between the first turbine assembly and the second turbine assembly, the gap in fluid communication with the first flow path and the second flow path. A washer is downstream of the first turbine assembly. The washer has an annular body including a deflector between the first turbine assembly and the second turbine assembly, the deflector obstructing the first flow path and extending toward the second flow path.

### TECHNICAL FIELD

The application relates generally to gas turbine engines and, more particularly, to key washers for turbine assemblies of gas turbine engines.

### BACKGROUND OF THE ART

Operation of gas turbine engines results in temperatures that may vary from ambient at the inlet to well above 1000 C downstream therefrom, for example inside the combustion section. Conventionally, cooling systems are used to compensate for combustion temperatures exceeding that which some components of the engine are designed to endure. For instance, a turbine rotor may be cooled by circulating air from relatively cooler portions of the engine, either axially through its hub or radially along its disc. Nonetheless, thermal gradients occur across some engine components, resulting in stresses that may undesirably affect engine efficiency and component life. Moreover, in practice, these thermal gradients may vary over the life of the engine, both in terms of location and magnitude. Improvements are therefore desirable.

### SUMMARY

In accordance with an embodiment, there is provided a gas turbine engine comprising: a shaft about an axis; a first turbine assembly mounted to the shaft, a first flow path and a second flow path extending through first turbine assembly along the axis, the second flow path located radially inward of the first flow path relative to the axis; a second turbine assembly about the axis downstream of the first turbine assembly, with a gap defined between the first turbine assembly and the second turbine assembly, the gap in fluid communication with the first flow path and the second flow path; and a washer downstream of the first turbine assembly, the washer having an annular body including a deflector between the first turbine assembly and the second turbine assembly, the deflector obstructing the first flow path and extending toward the second flow path.

In accordance with another embodiment, there is provided a method of redirecting a flow in a gas turbine engine, the method comprising: directing a first flow through a first flow path of a first turbine disc along an axis of the gas turbine engine; directing a second flow through a second flow path of the first turbine disc inward the first flow path relative to the axis along the axis; and deflecting the first flow downstream of the first turbine disc to direct the first flow toward the second flow downstream of the first turbine disc.

In accordance with yet another embodiment, there is provided a washer for a gas turbine engine, the washer comprising: a first ring portion; at least one first keying feature extending outwardly from a peripheral surface of the first ring portion; at least one second keying feature extending from an upstream surface of the first ring portion transverse to the peripheral surface; and a second ring portion radially inward of the first ring portion, the second ring portion defining a deflector surface transverse to an axis of the first ring portion.

### DESCRIPTION OF THE DRAWINGS

Reference is now made to the accompanying figures in which:

FIG. 1 is a schematic cross-sectional view of a gas turbine engine featuring a key washer in accordance with the present disclosure;

FIG. 2 is an isometric view taken from an upstream side of a key washer of a first turbine of the turbine section of FIG. 1;

FIG. 3 is a schematic representation of a portion of the turbine section of the gas turbine engine of FIG. 1, showing a portion of the turbine section of the engine of FIG. 1 having the key washer of FIG. 2;

FIG. 4 is a close-up view of the portion of the turbine section of FIG. 3, schematically representing the key washer deflecting a first air flow toward a second air flow in a gap of the portion of the turbine section of FIG. 3; and

FIG. 5 is a flow chart of a method of deflecting flow in a gas turbine engine downstream of a turbine disc of the gas turbine engine using the key washer of FIG. 2.

### DETAILED DESCRIPTION

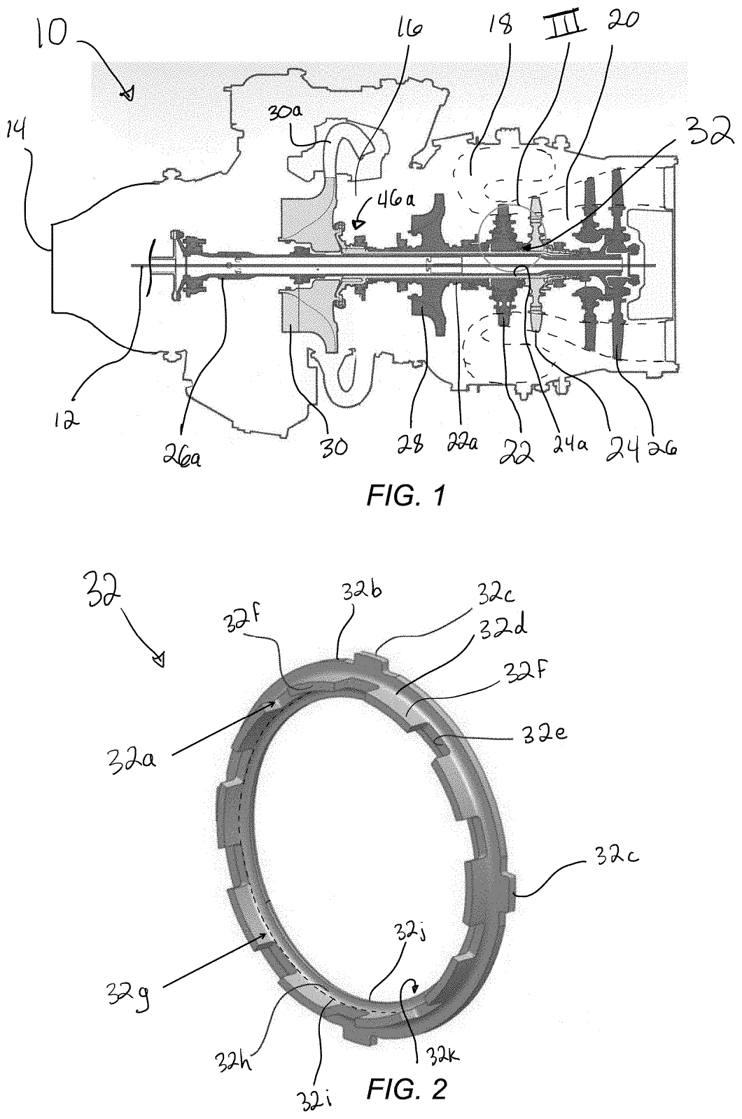

FIG. 1 illustrates a gas turbine engine 10 of a type preferably provided for use in subsonic flight, generally comprising in serial flow communication along an axis 12 of the engine 10 an inlet section 14 through which ambient air enters the engine 10, a compressor section 16 for pressurizing the air, a combustion section 18 in which pressurized air is mixed with fuel and ignited for generating an annular stream of hot combustion gases, and a turbine section 20 for extracting energy from the combustion gases. In this embodiment, the turbine section 20 includes a first turbine 22, a second turbine 24 and a power turbine 26. Other embodiments with fewer or more turbines are The first turbine 22 may be a high-pressure turbine drivingly connected to a first impeller 28 of the combustion section 18 via a hollow first shaft 22a collinear with the axis 12. The second turbine 24 may be a low-pressure turbine drivingly connected to a second impeller 30 of the compressor section 16 via a hollow second shaft 24a. The second shaft 24a extends coaxially inside the first shaft 22a. The power turbine 26 may be a two-stage power turbine drivingly connected to a propeller (not shown) disposed upstream of the inlet section 14 via a hollow third shaft 26a. The third shaft 26a extends coaxially inside the second shaft 24a. The first, second and third shafts 22a, 24a, 26a are rotatable relative to one another about the axis 12 of the engine 10 with their respective turbines.

A washer 32 of the first turbine 22 (in this case a key washer, characteristics of which will be described in more detail hereinbelow), is disposed along the axis 12 upstream of the second turbine 24. Referring to FIG. 2, the washer 32 is shown in more detail. The washer 32 has opposite upstream and downstream sides along a washer axis. The washer 32 has a first ring portion 32a surrounding the washer axis. In an embodiment, the washer axis is collinear or minimally offset from the axis 12 when the washer 32 is installed in the engine 10. The first ring portion 32a is circumscribed between an inner diameter and an outer diameter that lay in a plane to which the washer axis is normal. The washer 32 may be configured to rotationally engage with other components of the engine 10 via the first ring portion 32a upon rotation about the washer axis. For instance, the first ring portion 32a may have one or more anti-rotational features (i.e., first keying features) disposed about the washer axis. In this embodiment, the first ring portion 32a has an outer peripheral surface 32b from which first keys 32c of the washer 32 extend outwardly relative to the washer axis. The first keys 32c may have a shape complementary to that of a component of the engine 10 so as to be engageable therewith. The first keys 32c may be evenly spaced around the washer axis. In this embodiment, a total of four first keys 32c is provided, oriented radially relative to the washer axis and angularly spaced relative to one another by about 90 degrees. In other embodiments, the first keys 32c may be provided in different amounts, may be spaced otherwise, and may be oriented in ways other than substantially radially. In yet other embodiments, a sole first key 32c may be provided. It shall be understood that the first keys 32c define first keying features of the washer 32, i.e., anti-rotational features of the washer 32 configured to hinder rotation thereof about the washer axis relative to a first component of the engine 10 interfacing therewith. In some embodiments, anti-rotational features other than the first keys 32c may be used to hinder rotation, such as fasteners or other shapes which may adequately mesh with a corresponding complementary shape of the first component of the engine 10.

Further, the first ring portion 32a may have an annular ridge 32d disposed about the washer axis inward of the outer surface 32b. The annular ridge 32d may otherwise be flush with the outer surface 32b. The annular ridge 32d may have one or more anti-rotational features (i.e., second keying features) disposed about the washer axis. The annular ridge 32d may extend from an upstream surface of the first ring portion 32a oriented transversely to the outer surface 32b and in a generally axial direction, such as by being parallel to the washer axis. The annular ridge 32d may have a shape complementary to that of components of the engine 10 so as to be engageable therewith. For example, the annular ridge 32d may have a plurality of slots 32e disposed circumferentially such that a remainder of the annular ridge 32d forms a crenelated pattern facing away from the upstream side of the washer 32. In this embodiment, the slots 32e may be described as keying slots, and the remainder of the annular ridge 32d may be described as defining a plurality of second keys 32f. The slots 32e may be evenly spaced around the washer axis. For example, a total of ten slots 32e may be provided and be angularly spaced relative to one another by about 36 degrees. In other embodiments, the annular ridge 32d may be oriented in ways other than parallel. The slots 32e may be provided in different amounts and may be spaced otherwise. In yet other embodiments, a sole slot 32e may be provided. It shall be understood that the annular ridge 32d defines second keying features of the washer 32, i.e., anti-rotational features of the washer 32 configured to hinder rotation thereof about the washer axis relative to a second component of the engine 10 interfacing therewith. In some embodiments, anti-rotational features other than the slots 32e and the second keys 32f may be used to hinder rotation, such as fasteners or other shapes which may adequately mesh with a corresponding complementary shape of the second component of the engine 10.

It shall also be understood that the first and second keying features together form an anti-rotational feature of the washer 32 configured to hinder rotation of any one of the first component and the second component of the engine 10 relative to the other about the washer axis. In some embodiments, anti-rotational features other than the first and second keying features may be used to hinder rotation between components of the engine 10 interfacing with the washer 32.

The washer 32 has a deflector 32g forming a second ring portion inward the first ring portion 32a relative to the washer axis. As such, the first ring portion 32a may form an outer diameter of the washer 36 defined relative to the washer axis, and the deflector 32g may form an inner diameter of the washer 32 inward the outer diameter relative to the washer axis. The first ring portion 32a and the deflector 32g may be interconnected, such that the washer 32 forms a unitary piece. The unitary piece the washer 32 defines may be a monolithic body. In other embodiments, the first ring portion 32a and the deflector 32g may be separate components arranged to be attachable to one another or otherwise rotationally engageable relative to one another about the washer axis.

The deflector 32g has a deflector surface 32h facing upstream and configured to redirect a flow directed thereagainst. The deflector surface 32h is shaped to redirect the flow in a desired direction. The flow may for example be directed against the deflector surface 32h in a path generally parallel to the washer axis. The desired direction may for example be inward from the deflector 32g, i.e., away from the deflector 32g toward the washer axis. The annular ridge 32d and the deflector 32g may be successively disposed along the washer axis. The deflector surface 32h may have an upstream boundary 32i flush with an inner surface of the annular ridge 32d and extend therefrom to a downstream boundary 32j so as to ramp away from the annular ridge 32d of the first ring portion 32a toward the washer axis. For instance, a normal of the deflector surface 32h may be directed toward the washer axis at its upstream boundary 32i. The normal of the deflector surface 32h may be directed upstream and parallel to the washer axis at its downstream boundary 32j. At the downstream boundary 32j, the normal of the deflector surface 32h may otherwise be directed upstream at an angle relative to the washer axis. The angle may be for example 45 degrees. The deflector 32g has a deflector surface 32k opposite the deflector surface 32h. In this embodiment, the deflector surfaces 32h, 32k meet at the downstream boundary 32j so as to form a vertex of the deflector 32g. In other embodiments, the deflector surfaces 32h, 32k may be spaced away from one another.

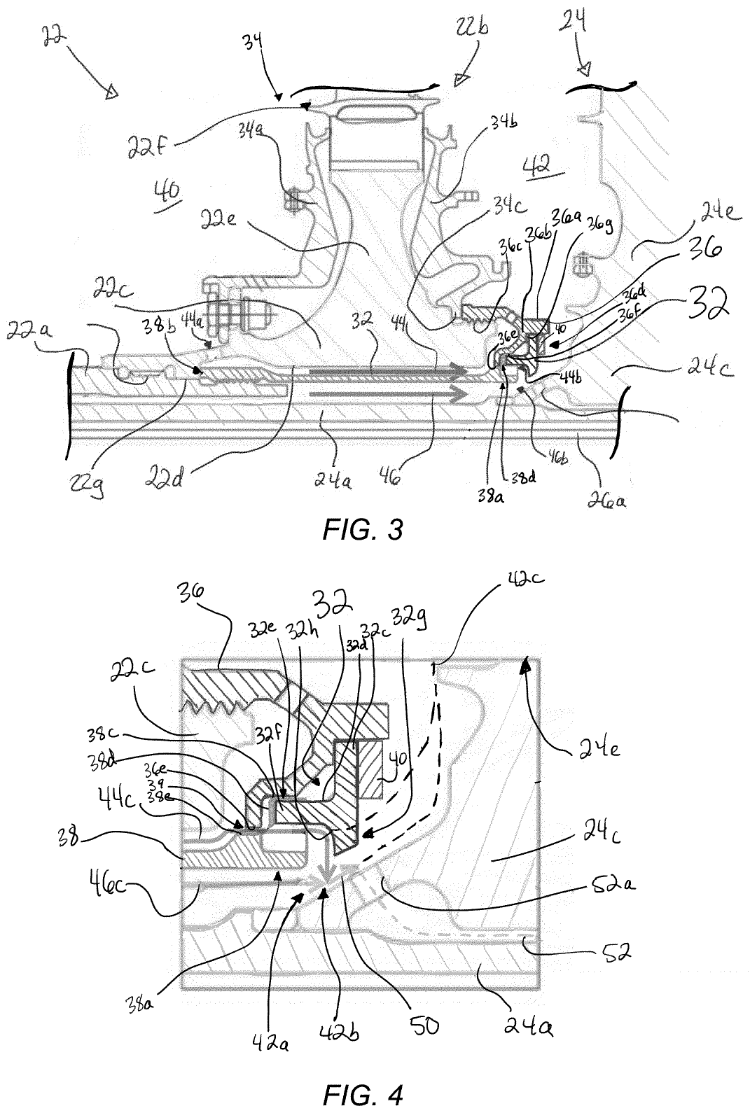

Referring to FIG. 3 the first turbine 22 is shown in more detail. The first turbine 22 may include a first disc 22b, the washer 32, disc covers 34, a first nut 36 and a second nut 38. The first disc 22b has a first hub defining opposite ends of the first disc 22b. The first hub 22c defines a first disc bore 22d between its opposite ends. A first web 22e extends generally radially from the first hub 22c to a blade 22f (not shown in detail) of the first disc 22b. An upstream hub portion is disposed around the first shaft 22a whereas a downstream hub portion is cantilevered relative to the first shaft 22a. An upstream cover 34a and a downstream cover 34b may be disposed on either sides of the first disc 22b and fastened to the upstream and downstream hub portions, respectively.

The first nut 36 is disposed downstream of the first disc 22b and joined thereto. For example, the first nut 36 may be fastened to the downstream hub portion of the first disc 22b. The first nut 36 has an outer, circumferential wall 36a and opposite upstream and downstream sides as delimited by a transverse nut wall 36b. Upstream and downstream outer bores 36c, 36d of the first nut 36 extend coaxially from either sides of the first nut 36 toward the transverse nut wall 36b thereof. An inner bore 36e of the first nut 36 coaxial with the outer bores 36c, 36d extends through the transverse nut wall 36b.

The first nut 36 is shown in a fastened position relative to the first disc 22b. A downstream end of the first hub 22c is received by the upstream outer bore 36c, to which the first nut 36 is fastened via threading. The downstream cover 34b and the first nut 36 may be successively disposed downstream of the first web 22e such that the downstream cover 34b is fastened to the first disc 22b by the first nut 36. The first nut 36 is screwed relative to the first hub 22c such that an annular flange 34c of the downstream cover 34b is held between the upstream side of the first nut 36 and a shoulder of the first hub 22c. The first nut 36 may be configured such that in the fastened position, the transverse nut wall 36b is spaced away from the downstream end of the first hub 22c.

The first nut 36 may be configured so as to be engageable with the washer 32 via its downstream side. For instance, the transverse nut wall 36d may be shaped so as to define a socket 36f at the bottom of the downstream outer bore 36d adjacent the inner bore 36e. The socket 36f may be sized for receiving the annular ridge 32f of the washer 32. The first nut 36 may have one or more first slots 36g disposed downstream of the socket 36f and outward from the downstream outer bore 36d. The one or more first slots 36g may have a shape complementary to that of the one or more first keys 36c of the washer 32 so as to be engageable therewith. The first nut 36 may be configured to engage with the washer 32 via the one or more first slots 36g upon rotation about the axis 12, to hence block rotation of the assembly. Any one of the first slots 36g of the first nut 36 may be engageable with any one of the first keys 32c of the washer 32.

The second nut 38 has a downstream nut portion 38a and an upstream nut portion 38b opposite the downstream nut portion 38a. The second nut 38 may be configured so as to interface with the first nut 36 via the downstream nut portion 38a. For example, the downstream nut portion 38a may have a periphery 38c having a shape generally matching that of the socket 36f of the first nut 36 so as to be receivable thereby. The periphery 38c may be circumscribed by a diameter greater than that of the inner bore 36e of the first nut 36. The upstream nut portion 38b may be circumscribed by a diameter lesser than that of the inner bore 36e. Thus, the second nut 38 may interface with the first nut 36 upon the upstream nut portion 38b being inserted through the inner bore 36e and upon the downstream nut portion 38a being received by the socket 36f.

The second nut 38 may be configured so as to be engageable with the washer 32 via its downstream nut portion 38a. For example, the second nut 38 may have an anti-rotational feature, such as one or more keys 38d inward of the periphery 38c. The one or more keys 38d may have a shape complementary to that of the one or more second keying features of the washer 32 so as to be engageable therewith. Any one of the keys 38d of the second nut 38 may be engageable with any one of the slots 32e of the washer 32.

The second nut 38 may be configured so as to be fastenable with the first shaft 22a via its upstream nut portion 38b upon its downstream nut portion 38a being disposed downstream of the first disc bore 22d and the first shaft 22a being disposed inside the first disc bore 22d. For example, the upstream nut portion 38b may be circumscribed by a diameter lesser than that of the first disc bore 22a and may have a length corresponding to a distance between opposite ends of the upstream and downstream hub portions. The second nut 38 is shown in a fastened position relative to the first shaft 22a, the first disc 22a and the first nut 36. In this position, the downstream nut portion 38a is received by the socket 36f. The second nut 38 extends from the downstream nut portion 38a through the inner bore 36e to its upstream nut portion 38b disposed inside the first disc bore 22a. The upstream nut portion 38b is fastened to the first shaft 22a via threading. The second nut 38 is screwed relative to the first shaft 22a such that an annular flange 22g of the upstream hub portion is held between an upstream side of the second nut 38 and a downstream-facing shoulder of the first shaft 22a. The second nut 38 is configured such that in the fastened position, the second nut 38 is coaxial with the first shaft 22a and the first disc bore 22d. The second nut 38 may also be configured such that a peripheral surface 38e upstream of its downstream portion 38a forms a gap 39 relative to the inner bore 36e of the first nut 36 upon the nuts 36, 38 being in their respective fastened positions, the gap 39 forming a portion of the first flow path 44 (e.g., of annular shape considering the annularity of the components defining the flow path 44). The nuts 36, 38 may be structured and arranged relative to one another such that dimensions of the gap 39 remain within desirable ranges despite thermal deformation occurring as the engine 10 is operated under certain conditions. As such, the gap 39 may be said to be a controlled gap.

The washer 32 is shown in an engaged position (i.e., in this case, a keyed position) relative to the first and second nuts 36, 38. In the engaged position, the washer 32 may be coaxial with the first and second nuts 36, 38 and the washer axis may be collinear with the axis 12 of the engine 10. Further, rotation of either the first nut 36 or the second nut 38 about the axis 12 relative to the first disc 22b may be blocked by the first and second nuts 36, 38 and the washer 32 being in the engaged position. Indeed, the threading which fastens the first nut 36 and the threading which fastens the second nut 38 may be of an opposite handedness. The washer 32 being rotationally engaged with both nuts 36, 38 may thus prevent the nuts 36, 38 from rotating about the axis 12 relative to the first disc 22b, either with one another or independently. Further, upon mounting the first disc 22b about the first shaft 22a, fastening the first nut 36 to the first disc 22b, and fastening the second nut 38 to the first shaft 22a, placing the washer 32 in the engaged position may block any movement between the first disc 22b and the first shaft 22a. The first disc 22b, the disc covers 34, and the nuts 36, 38 may be said to form a first turbine assembly, of which the washer 32 may block rotation relative to the first shaft 22a about the axis 12.

A retaining ring 40 may be disposed downstream of the washer 32 about the axis 12. The retaining ring 40 may be configured so as to hinder translation of the washer 32 along the axis 12 relative to the first nut 36. For example, upon the washer 32 being in the engaged position, the retaining ring 40 may be joined to the first nut 36 (for example via retention in a circumferential groove surrounding the downstream outer bore 36c or via friction) so as to retain the washer 32 in position relative to the first nut 36.

Still referring to FIG. 3, annular gaps in serial flow communication are formed around the second nut 38 relative to the first disc bore 22a and to the inner nut bore 36e, respectively. The annular gaps are in fluid communication with upstream and downstream interior spaces 40, 42 of the turbine section 20 via a first inlet 44a of the upstream hub portion and a first outlet 44b of the downstream nut portion 38a, defining a first flow path 44 of the first turbine 22 therebetween. The upstream interior space 40 is heated due to thermal energy transferred from the combustion section 18. As such, a first flow 44c (FIG. 4) of air flowed from the upstream interior space 40 and throughout the first flow path 44 is substantially hot.

The keys 38d of the second nut 38 may be disposed outward of the first outlet 44b relative to the axis 12 such that upon engagement of the one or more slots 32e therewith, the annular ridge 32d is clear of the first flow 44c. The keys 38d may be configured such that upon engagement of the one or more slots 32e therewith, the deflector 36g is positioned downstream of the first flow path 44 so as to faces the first flow 44c. The downstream nut portion 38a may be configured to rotationally engage with the washer 32 via the keys 38d upon rotation about the axis 12.

A second flow path 46 of the first turbine 22 is defined by annular gaps in serial flow communication formed around the second shaft 24a relative to an interior wall of the first shaft 22a and an interior wall of the second nut 38, respectively. The second flow path 46 is in fluid communication with an interior space of the compressor section 16 via a second inlet 46a (FIG. 1) and with the downstream interior space 42 via a second outlet 46b. The second outlet 46b is formed in part by the downstream nut portion 38a and located radially inward of the first outlet 44b. The interior space of the compressor section 16 being at a temperature generally greater than ambient temperature and lesser than a second impeller temperature downstream of the second impeller 30. Thus, a second flow 46c (FIG. 4) of air flowed from the compressor section 16 and throughout the second flow path 44 is generally colder relative to the first flow 44c. The second impeller temperature may for example be inside a diffuser conduit 30a in downstream serial flow communication with the second impeller 30. The interior space of the compressor section 16 may be heated up via the diffuser conduit 30a yet remain relatively cooler due to thermal losses via other adjacent media disposed between the compressor section 16 and an environment exterior to the engine 10.

Turning now to FIG. 4, a configuration of the washer 32 for redirecting the first flow 44c toward the second flow 46c will be described. A portion of the upstream interior space 42 located radially inward of the first hub 22c and of a second hub 24c of the second disc 22b defines a gap 42a. With the washer 32 in the engaged position, its deflector 32g is disposed inside the gap 42a. The washer 32 is configured such that, in the engaged position, the deflector 32g forms a third flow path in fluid communication with the first flow path 44c and directed toward the second flow path 46c. The deflector surface 32h is shaped to redirect a flow toward a desired location. Indeed, the upstream deflector surface 32h redirects the first flow 44c toward the second flow 46c such that the flows 44c, 46c cross at the desired location represented by intersection 42b. Deflection of the first flow 44c results in a mixed flow 50 flowing downstream from the intersection 42b. The mixed flow 50 has a temperature between that of the first and second flows 44c, 46c. Hence, thermal gradients in portions of the first and second turbines 22 located downstream of the intersection 42b may be desirably reduced upon exposure to the mixed flow 50. Reduction of thermal gradients and corresponding thermal stresses in such turbine components may, under certain circumstances, desirably increase a lifespan of such turbine components. Thus, the washer 32 is configured such that the intersection is located inside the gap 42a and upstream of some such turbine components. For example, in this embodiment, the washer 32 is configured such that the intersection 42b is located upstream of an inlet 52a of a fourth flow path 52 defined by the second turbine 24, such that a portion of the mixed flow 50 may flow through the fourth flow path 52.

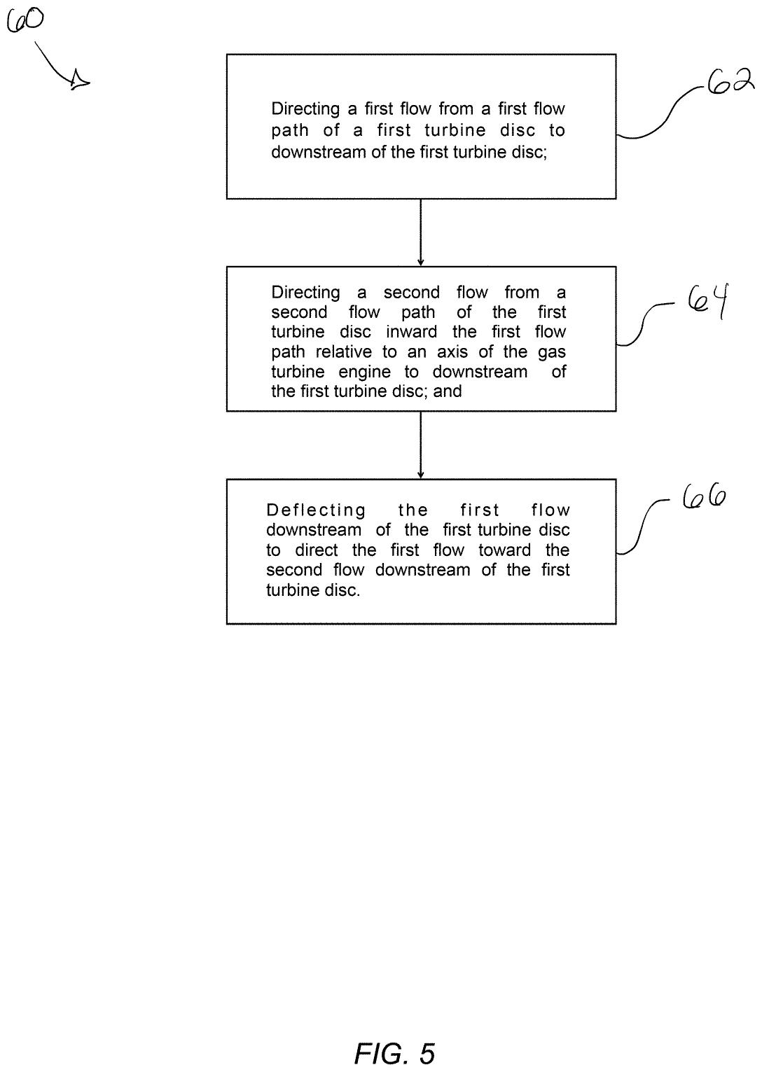

With reference to FIG. 5 a method 60 of redirecting the first flow 44c in the gas turbine engine 10 will now be described.

The method 60 starts at step 62 with directing the first flow 44c from the first flow path 44 of the first turbine disc 22b to downstream thereof along the axis 12. In some embodiments, the method 60 may provide controlling at least one of a flow rate and a temperature of the first flow 44c upstream of the first turbine disc 22b. The flow rate and the temperature may respectively be controlled to be at a predetermined value or within a predetermined range of values.

From step 62, the method 60 goes to step 64 with directing the second flow 46c from the second flow path 46 of the first turbine disc 22b inward the first flow path 44 to downstream thereof along the axis 12. In some embodiments, the method 60 may provide controlling at least one of a flow rate and a temperature of the second flow 46c upstream of the first turbine disc 22b. The flow rate and the temperature may respectively be controlled to be at a predetermined value or within a predetermined range of values.

From step 64, the method 60 goes to step 66 with deflecting the first flow 44c downstream of the first turbine disc 22b to direct the first flow 44c toward the second flow 46c downstream of the first turbine disc 22b. In some embodiments, the method 60 may provide deflecting the first flow 44c upstream of the gap 42a prior to deflecting the first flow 44c downstream of the first turbine disc 22b.

In some embodiments, the method 60 further comprises mixing the first flow 44c and the second flow 46c into the mixed flow 50 at the intersection 42b located downstream of the first turbine disc 22b upon deflecting the first flow 44c.

In some such embodiments, the intersection 42b is located in the gap 42a defined between the first turbine disc 22b and the second turbine disc 24b downstream of the first turbine disc 22b. The intersection 42b may be located upstream of the inlet 52a of the flow path 52 defined by the second turbine 24.

In some embodiments, the method 60 further comprises placing a washer having a deflector such as the deflector 32g downstream of the first turbine disc 22b such that its deflector faces the first flow 44c to deflect the first flow 44c. In some such embodiments, the washer may have no first and second keying features such as the keys 32c and the slots 32e provided that the deflector remains positioned so as to face the first flow 44c to deflect the first flow 44c upon operating the engine 10.

In some embodiments, the method 60 further comprises placing the washer 32 downstream of the first turbine disc 22b such that the deflector 32g faces the first flow 44c to deflect the first flow 44c.

In some such embodiments, the method 60 further comprises removing an existing key washer from downstream of the first turbine disc 22b prior to placing the washer 32 downstream of the first turbine disc 22b. The existing key washer may have no deflector such as the deflector 32g, and may be keyed relative to the first turbine disc 22b and to the first shaft 22a.

In some embodiments, the method 60 further comprises controlling the deflection of the first flow 44c to redirect the first flow 44c from toward the location of the intersection 42b to toward a desired location downstream of the first turbine disc 22b. Thus, the first flow 44c and the second flow 46c may be mixed into the mixed flow 50 at the desired location. For example, one may control the deflection of the first flow 44c by replacing a first washer having a first deflector configured for directing the first flow 44c toward the location of the intersection 42b with a second washer having a second deflector configured for directing the first flow 44c toward the desired location.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A gas turbine engine comprising:
a shaft about an axis;
a first turbine assembly mounted to the shaft, a first flow path and a second flow path extending through first turbine assembly along the axis, the second flow path located radially inward of the first flow path relative to the axis;
a second turbine assembly about the axis downstream of the first turbine assembly, with a gap defined between the first turbine assembly and the second turbine assembly, the gap in fluid communication with the first flow path and the second flow path; and
a washer downstream of the first turbine assembly, the washer having an annular body including a deflector between the first turbine assembly and the second turbine assembly, the deflector obstructing the first flow path and extending toward the second flow path.

2. The gas turbine engine of claim 1, wherein the washer has an outer ring portion configured to hinder rotation of the shaft and the first turbine assembly relative to one another about the axis, the deflector forming an inner ring portion of the washer inward the outer ring portion relative to the axis.

3. The gas turbine engine of claim 2, wherein the outer ring portion and the inner ring portion form a monolithic body.

4. The gas turbine engine of claim 2, wherein the first turbine assembly includes a first disc about the axis, a first nut fastened to the first disc about the axis and a second nut fastened to the shaft about the axis, the outer ring portion engaging with the first disc via the first nut and with the first shaft via the second nut to hinder the rotation about the axis.

5. The gas turbine engine of claim 3, wherein the second nut extends inside the first disc along the first flow path to downstream of the first nut, an outlet of the first flow path defined in the second nut inward of the first nut relative to the axis, the deflector extending from outward to inward of the outlet of the first flow path relative to the axis.

6. The gas turbine engine of claim 1, wherein the deflector is shaped so as to form a third flow path in fluid communication with the first flow path, the third flow path directed from the first flow path toward the second flow path.

7. The gas turbine engine of claim 6, wherein a fourth flow path in fluid communication with the gap extends downstream therefrom along the axis, the third flow path directed to upstream of the fourth flow path.

8. The gas turbine engine of claim 7, wherein the fourth flow path is located inward of the first flow path relative to the axis, the third flow path intersecting with the first flow path at an intersection located inward of an outlet of the fourth flow path relative to the axis.

9. A method of redirecting a flow in a gas turbine engine, the method comprising:
directing a first flow through a first flow path of a first turbine disc along an axis of the gas turbine engine;
directing a second flow through a second flow path of the first turbine disc inward the first flow path relative to the axis along the axis; and
deflecting the first flow downstream of the first turbine disc to direct the first flow toward the second flow downstream of the first turbine disc.

10. The method of claim 9, further comprising mixing the first flow and the second flow into a mixed flow at an intersection located downstream of the first turbine disc upon deflecting the first flow.

11. The method of claim 10, wherein the intersection is located in a gap defined between the first turbine disc and a second turbine disc downstream of the first turbine disc.

12. The method of claim 11, wherein the intersection is located upstream of an inlet of a flow path defined through the second turbine disc.

13. The method of claim 9, further comprising placing a washer downstream of the first turbine disc such that a deflector of the washer faces the first flow to deflect the first flow.

14. The method of claim 13, wherein a conventional key washer downstream of the first turbine disc is keyed relative to the first turbine disc and to the first shaft, the method further comprising replacing the conventional key washer with the washer.

15. A washer for a gas turbine engine, the washer comprising:
a first ring portion;
at least one first keying feature extending outwardly from a peripheral surface of the first ring portion;
at least one second keying feature extending from an upstream surface of the first ring portion transverse to the peripheral surface; and
a second ring portion radially inward of the first ring portion, the second ring portion defining a deflector surface transverse to an axis of the first ring portion.

16. The washer as claimed in claim 15, wherein the first ring portion includes an annular ridge extending from the upstream surface along the washer axis, the annular ridge having the second keying features; and the deflector surface having an upstream boundary flush with the annular ridge and extending from the upstream boundary to a downstream boundary so as to ramp away from the annular ridge toward the washer axis.

17. The washer as claimed in claim 16, wherein the downstream boundary of the deflector surface forms an apex of the deflector.

18. The washer as claimed in claim 16, wherein the washer has a monoblock body.

19. The washer as claimed in claim 16, comprising a plurality of the at least one first keying feature.

20. The washer as claimed in claim 16, comprising a plurality of the at least one second keying feature.
